(19) United States
(12) Patent Application Publication
(10) Pub. No.: US 2006/0016324 A1
(43) Pub. Date: Jan. 26, 2006

(54) Sound outputting apparatus having compensation characteristics

(75) Inventor: Kuan-Hong Hsieh, Tu-cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/173,130

(22) Filed: Jul. 1, 2005

(30) Foreign Application Priority Data
Jul. 2, 2004 (CN) 200410027983.4

(51) Int. Cl. G10H 7/00; G10H 1/06

(52) U.S. Cl. 84/622

(57) ABSTRACT

A sound outputting apparatus having compensation characteristics for improving the timbre of output sound is provided herein. The apparatus (10) includes at least one speaker (12) and a memory unit (14). The speaker has real characteristics per se and used to transform audio signals into sounds. The memory unit stores compensation parameters for the speaker, each of which is built according to the corresponding real characteristics of the speaker, and is adapted to minimize or even eliminate deviations between outputs of the speaker due to the corresponding real characteristics of the speaker. A compensation system (20) which is used to build the compensation parameters for the speaker, and a sound outputting system having compensation characteristics which adapts the sound outputting apparatus to output sounds, are also provided.

### BACKGROUND OF THE INVENTION

1. Field of the Invention

The present invention relates to sound outputting apparatuses, and particularly to a sound outputting apparatus having compensation characteristics.

2. Description of the Related Art

A speaker is used to convert audio signals within a certain frequency range into sounds having adequate sound pressure levels. For true listening pleasure, users require a speaker that turns audio signals into high fidelity sound.

The voices of humans and various sounds of music are various signals having very complicated waveforms. The frequency of sound audible to the human ear is generally in the range from 20 Hz to 20 KHz. The frequency range of speech is mainly from 150 Hz to 4 KHz, and the frequency range of music is mainly from 40 Hz to 18 KHz. The energy of the human voice is mostly distributed in the frequency range of 200 Hz-3.5 KHz. Therefore, in order to correctly play such a wide variety of signals and attain high quality timbre, a speaker is required to have a wide frequency response characteristic, adequate sound pressure levels, and a large dynamic range. Further, a speaker is also desired to attain a perfect frequency-efficiency characteristic and a perfect frequency-phase delay characteristic. If this is achieved, the output of the speaker maintains high power efficiency and low phase leads or delays as compared to the input of the speaker. In the following description, phase leading and phase delaying are collectively referred to simply as phase delaying.

A conventional speaker system typically has a frequency-efficiency characteristic and a frequency-phase delay characteristic. These characteristics typically cause much deviation of the output of the speaker from the input of the speaker. That is, the output is far from an ideal output, and frequently results in poor timbre. To solve such problem, some special systems correct characteristics which affect the frequency-efficiency characteristic and the frequency-phase delay characteristic of a speaker. For example, one kind of correcting system corrects for adverse characteristics such as reactance, inertia and response of a power amplifier driven load such as a speaker system. The correcting system works by utilizing a program voltage and a reference load, which responds to the program voltage to develop a correction voltage signal for the driven load. However, the correcting system employs numerous resistances and capacitances to achieve its function, and is unduly complicated. Further, the system cannot compensate according to individual characteristics of the drive load.

Thus, an improved sound outputting apparatus and system which have compensation characteristics and can overcome the above-mentioned problems are desired.

### SUMMARY

To solve the above-mentioned and other problems, a sound output apparatus having compensation characteristics (hereinafter “the apparatus”) in accordance with the preferred embodiments of the present invention is provided herein. The apparatus includes one or more sound outputting unit and a memory unit. Each type of the sound outputting units has been assigned an ID (identification) code and is used transform audio signals in a preset frequency range into sounds having corresponding sound pressure levels. The sound outputting units have real characteristics per se which cause outputs of the sound outputting units to deviate from ideal outputs. The memory unit stores ID codes and compensation parameters for each types of the sound outputting units. Each of the compensation parameters being built according to the corresponding real characteristics of the type of the sound outputting units, and is adapted to minimize or even eliminate deviations of the outputs of the sound outputting units due to the corresponding real characteristics of the sound outputting units.

In addition, to build the compensation parameters for each type of the sound outputting units, a compensation system in accordance with the preferred embodiments of the present invention is also provided herein. The compensation system includes a controllable signal source, a sensing apparatus, a reference source and a control unit. The controllable signal source is adapted to send audio signals to the sound outputting units. The sensing apparatus is adapted to sense outputs of the sound outputting units. The reference source is employed to have outputs indicating ideal outputs the sound outputting units to be attained. The control unit is employed to determine whether deviations between the outputs of the sound outputting units and the idea outputs fall within predetermined ranges, and storing compensation parameters in a memory if the deviations fall in the predetermined ranges, or regulating outputs of the controllable signal source if the deviations between the outputs of the sound outputting units and the idea outputs fall outside of the predetermined ranges.

Further, a sound outputting system having compensation characteristics (hereinafter “the system”), which adapts the sound outputting apparatus to output sounds, in accordance with a preferred embodiment of the present invention is also provided herein. The system includes the sound outputting apparatus and a device interconnected therewith. A sound outputting unit of the sound outputting apparatus receives audio signals from the device. The device generally includes a micro-controller, a signal processor and a signal source. The micro-controller reads an ID (identification) code of the sound outputting unit and determines whether the ID code exists in a memory unit of the sound outputting apparatus. If the ID code exists in the memory unit, the micro-controller reads the compensation parameters corresponding to the ID code and sends them to the signal processor 64 to regulate the outputs of the sound outputting unit. After regulation based on the compensation parameters, the sound outputting unit approaches or even reaches its ideal output.

Other advantages and novel features will become more apparent from the following detailed description when taken in conjunction with the accompanying drawings, in which:

### BRIEF DESCRIPTION OF THE DRAWINGS

FIG. 1 is a block diagram of a sound outputting apparatus having compensation characteristics in accordance with a preferred embodiment of the present invention;

FIG. 2 is a block diagram of a first compensation system for building compensation characteristics of the sound outputting apparatus of FIG. 1;

FIG. 3 is a block diagram of a second compensation system for building compensation characteristics of the sound outputting apparatus of FIG. 1;

FIG. 4 is a graph of frequency versus phase delay for one type of speaker according to a preferred embodiment of the present invention;

FIG. 5 is a graph of frequency versus efficiency for the speaker referred to in the above paragraph; and

FIG. 6 is a block diagram of a system for sound output having compensation parameters, in accordance with a preferred embodiment of the present invention;

### DETAILED DESCRIPTION OF THE PREFERRED EMBODIMENTS

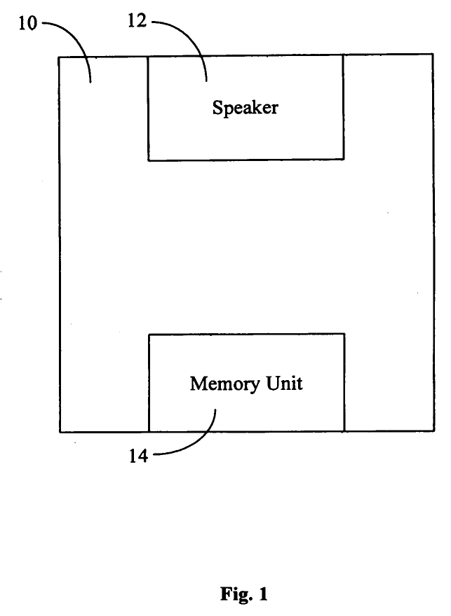

FIG. 1 is a block diagram of a sound outputting apparatus having compensation characteristics (hereinafter “the apparatus ”) in accordance with the preferred embodiment of the present invention. The apparatus 10 includes one or more speakers 12 (only one shown) and a memory unit 14. According to the preferred embodiment, the speaker 12 can be substituted by any other sound outputting unit which can transform audio signals into sounds, such as earphones or the like. The speaker 12, having been assigned an ID (identification) code, is used to transform audio signals in a preset frequency range into sounds having corresponding sound pressure levels. The speaker 12 has real characteristics per se, including but not being limited to a real frequency-efficiency characteristic and a real frequency-phase delay characteristic. The real characteristics cause outputs of the speaker 12 to deviate from ideal outputs of the speaker 12, and therefore corresponding compensation parameters are needed to make up for the deviations. The compensation parameters include a compensation frequency-efficiency parameter and a compensation frequency-phase delay parameter. Each of the compensation parameters is built according to the corresponding real characteristics of the speaker 12, and is adapted to minimize or even eliminate deviations between uncompensated outputs and ideal outputs of the speaker 12. The memory unit 14 is readable/writable, and used to store the ID (identification) code and the compensation parameters of the speaker 12. According to the preferred embodiment, the apparatus 10 is adapted to regulate the outputs of all those speakers 12 whose ID codes have been stored in the memory 14 in advance. An external device with which the apparatus 10 is connected, such as an MP3 player, a CD player or a host computer, validates the ID code of each speaker 12 according to the ID codes already in the memory 14. If the ID code of a speaker 12 is in the memory 14, a processor of the external device implements the compensation function for the speaker 12. Otherwise, the processor of the external device omits to regulate the output of the speaker 12, and the speaker 12 maintains its original timbres.

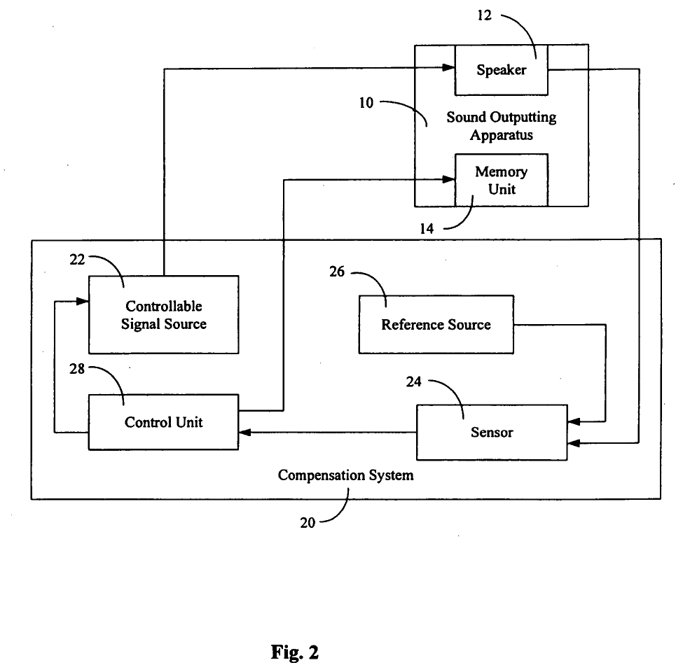

Referring also to FIG. 2, this is a block diagram showing relationships between a compensation system 20 and the apparatus 10, wherein the compensation system 20 is employed to build compensation parameters for the speaker 12. The compensation system 20 mainly includes a controllable signal source 22, a sensor 24, a reference source 26, and a control unit 28. The controllable signal source 22 respectively connects with the speaker 12 and the control unit 28, and is controlled by the control unit 28. The sensor 24 respectively connects with the speaker 12 and the reference source 26 at its input port, and connects with the control unit 28 at its output port. The reference source 26 is preferably an analog signal source, and has a plurality of outputs. In the preferred embodiment, the outputs of the reference source 26 are designated as ideal outputs of the speaker 12, and reflect an ideal frequency-phase delay characteristic and an ideal frequency-efficiency characteristic which the speaker 12 is expected to attain after compensation. The control unit 28 is connected to the memory unit 14 of the apparatus 10.

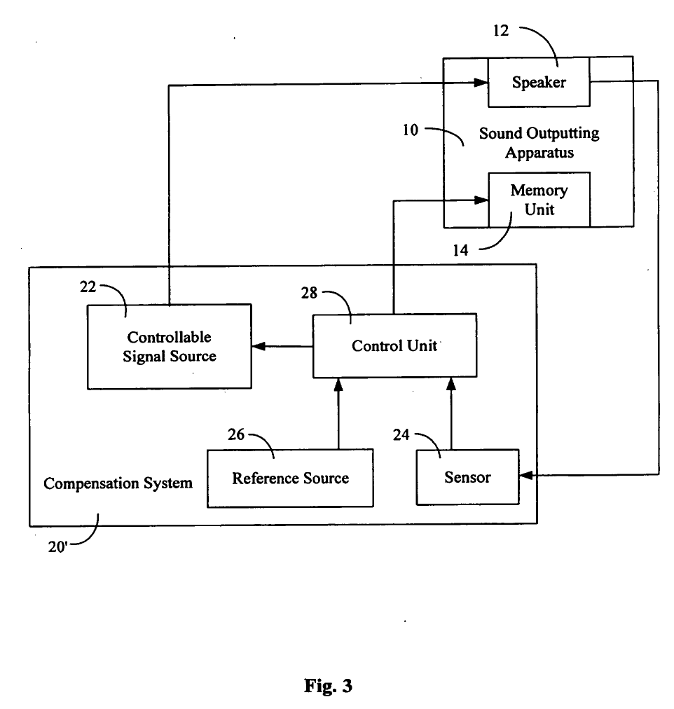

Referring also to FIG. 3, this is a block diagram showing relationships between an alternative compensation system 20′ and the apparatus 10. The compensation system 20′ is the same as the compensation system 20 of FIG. 2, except that the reference source 26 is preferably a digital signal source, and is connected with the control unit 28.

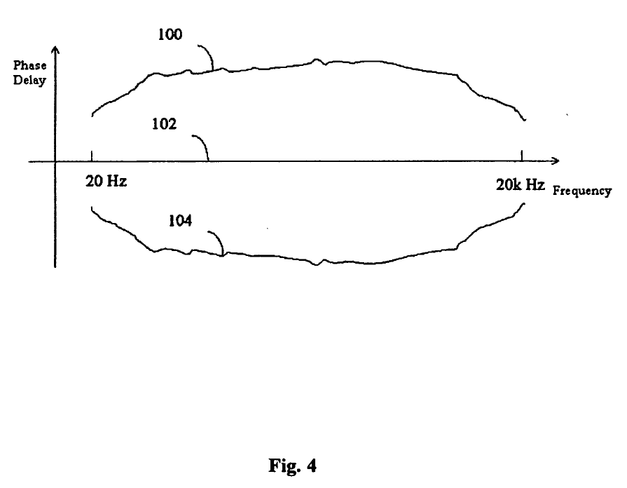

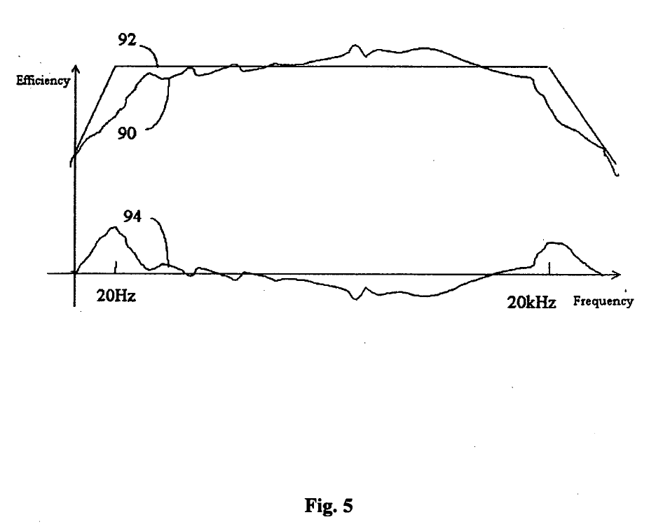

Referring also to FIGS. 4 and 5, these are a frequency-phase delay graph and a frequency-efficiency graph for the speaker 12. The controllable signal source 22 sends audio signals in a certain frequency range to the speaker 12. The speaker 12 receives the audio signals, and transforms the audio signals into sounds in a corresponding frequency range. Generally, sound frequencies audible to the human ear are in the range from approximately 20 Hz to 20 KHz. Therefore the audio signals with different frequencies in the range from 20 Hz to 20 KHz are selected to be transformed by the speaker 12 into sounds with corresponding frequencies. When not compensated, the sounds have phase delays and low efficiencies when compared to the corresponding audio signals, because of the real characteristics of the speaker 12. In FIGS. 4 and 5, curves 100 and 90 respectively represent the real frequency-phase delay characteristic and the real frequency-efficiency characteristic of the speaker 12, and lines 102 and 92 respectively depict an ideal frequency-phase delay characteristic and an ideal frequency-efficiency characteristic of the speaker 12. As seen in FIGS. 4 and 5, the curves 100 and 90 respectively deviate from the corresponding lines 102 and 92, which indicate that uncompensated outputs of the speaker 12 deviate from the ideal outputs. Thus, to adjust the respective deviations so that they fall within a predetermined acceptable range, a plurality of compensation parameters including frequency-phase delay parameters and frequency-efficiency parameters need to be built. The frequency-phase delay parameters and frequency-efficiency parameters are denoted respectively by curves 104 and 94 in FIGS. 4 and 5.

During the building of the compensation parameters, in one preferred embodiment according to FIG. 2, the sensor 24 first senses the output of the speaker 12, compares the output with the ideal output of the speaker 12 defined by the reference source 26, and sends the comparison results to the control unit 28. The control unit 28 determines whether deviations between the output of the speaker 12 and the ideal output fall within predetermined ranges according to the comparison results. In an alternative preferred embodiment according to FIG. 3, the sensor 24 only senses the output of the speaker 12, and outputs what it senses to the control unit 28. The control unit 28 compares the output of the speaker 12 with the ideal output, and produces comparison results. Similarly, based on the comparison results, the control unit 28 determines whether deviations between the output of the speaker 12 and the ideal output fall within predetermined ranges. In the preferred embodiments, the deviations between the output of the speaker 12 and the ideal output include a frequency-phase delay deviation and a frequency-efficiency deviation, and accordingly the predetermined ranges are preset to include a frequency-phase delay range and a frequency-efficiency range. If the deviations fall within the predetermined ranges, the control unit 28 sets the compensation parameters for the speaker 12 under this particular frequency at zero, and stores the compensation parameters in the memory unit 14. If the deviations fall outside of the predetermined ranges, the control unit 28 regulates the output of the controllable signal source 22 so as to change the output of the speaker 12 under this particular frequency, compares the output with the ideal output, and re-determines whether deviations fall within the predetermined ranges, based on the comparison results from the sensor. The above-described operations of changing the output, comparing the output with the ideal output, and re-determining based on the comparison results are repeated until the comparison results fall within the predetermined range. Finally, discrepancies between the latest output of the speaker 12 after regulation thereof and the original output of the speaker 12 are stored in the memory unit 14 as the compensation parameters for the speaker 12 under this frequency.

The above description relates to the building of compensation parameters for a particular speaker 12 under a particular frequency. However, the compensation system 20, 20′ also builds compensation parameters for the speaker 12 under any particular frequency. For such situations, the frequency of the output of the controllable signal source 22 needs to be changed to meet with the particular frequency. The compensation system 20, 20′ is also adapted to build compensation parameters for a plurality of speakers 12, and for any other type of sound outputting unit(s) which can transform audio signals into sounds.

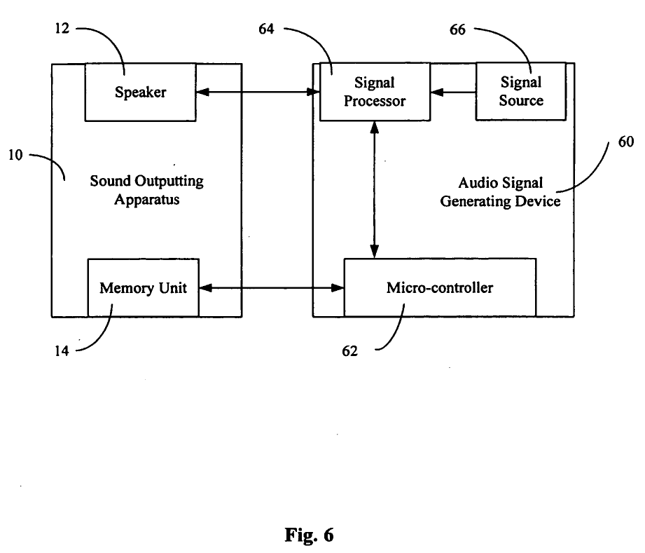

Referring also to FIG. 6, this is a block diagram of an exemplary application of the apparatus 10, which is connected with an audio signal generating device 60 (hereinafter, “the device 60”). In this application, the apparatus 10 and the device 60 together constitute a sound outputting system having compensation characteristics. The speaker 12 of the apparatus 10 receives audio signals from the device 60. The device 60 may be an MP3 player, a CD player, or a host computer, and generally includes a micro-controller 62, a signal processor 64, and a signal source 66. The memory unit 14 of the apparatus 10 is connected to the micro-controller 62. The micro-controller 62 and the signal source 66 are connected to the signal processor 64. The signal processor 64 is connected to the speaker 12. The micro-controller 62 reads the ID (identification) code of the speaker 12 and determines whether the ID code is valid; that is, the micro-controller 62 determines whether the ID code exists in the memory unit 14. If the ID code is valid, the micro-controller 62 reads the compensation parameters corresponding to the ID code from the memory unit 14, and sends the compensation parameters to the signal processor 64 to regulate the output of the speaker 12. After regulation based on the compensation parameters, the speaker 12 approaches or even attains its ideal output.

It is to be understood, however, that even though numerous characteristics and advantages of the preferred embodiments have been set forth in the foregoing description, together with details of the structures and functions of the preferred embodiments, the disclosure is illustrative only, and changes may be made in detail, especially in matters of type and arrangement of components within the principles of the invention to the full extent indicated by general meaning of the terms in which the appended claims are expressed.

We claim:

1. A method for improving timbre of outputting sounds of a sound outputting system, comprising the steps of:
retrieving real characteristics of at least one sound outputting unit, capable of transforming audio signals into said outputting sounds, of said sound outputting system;
presetting corresponding ideal characteristics to said real characteristics;
identifying comparison results of said real characteristics and said corresponding ideal characteristics within corresponding predetermined ranges;
modifying said outputting sounds of said at least one sound outputting unit when said comparison results are out of said corresponding predetermined ranges; and
repeating said retrieving and identifying steps so as to assure said comparison results are within said corresponding predetermined ranges.

2. The method according to claim 1, wherein said real characteristics comprise at least one real frequency-phase delay characteristic and at least one real frequency-efficiency characteristic.

3. The method according to claim 1, wherein corresponding compensation parameters are built and saved according to said comparison results for instantly future use based on frequency values of said outputting sounds.

4. The method according to claim 1, wherein said sound outputting system comprises a controller to perform said identifying step.

5. The method according to claims 3, wherein said sound outputting system comprises an audio signal generating device for compensating and modifying said outputting sounds by means of said corresponding compensation parameters.

6. A compensation system for establishing compensation parameters for one or more sound outputting units, comprising:
a controllable signal source for sending audio signals to the sound outputting units;
a sensing apparatus for sensing outputs of the sound outputting units;
a reference source having a plurality of outputs, the outputs being designated as ideal outputs of the sound outputting units; and
a control unit for determining whether deviations between the outputs of the sound outputting units and the ideal outputs fall within predetermined ranges, and for storing compensation parameters in a memory if the deviations fall within the predetermined ranges.

7. The compensation system according to claim 6, wherein the controllable signal source has a plurality of outputs, and the control unit is also for regulating the outputs of the controllable signal source if the deviations between the outputs of the sound outputting units and the ideal outputs are beyond the predetermined ranges.

8. A sound outputting system having compensation characteristics for outputting of sound, the sound outputting system having a sound outputting apparatus comprising:
one or more sound outputting units for transforming audio signals into sounds, each of the sound outputting units having one or more real characteristics; and
a memory unit for storing compensation parameters of the sound outputting units, the compensation parameters being established according to the real characteristics of the sound outputting units.

9. The sound outputting system according to claim 8, further comprising a device for generating audio signals to the sound outputting units, reading the compensation parameters from the memory unit, and regulating outputs of the sound outputting units according to the compensation parameters.

10. The sound outputting system according to claim 8, wherein the real characteristics comprise one or more real frequency-phase delay characteristics and one or more real frequency-efficiency characteristics.

11. The sound outputting system according to claim 8, wherein the memory unit is readable and writable.

12. The sound outputting system according to claim 8, wherein the compensation parameters comprise one or more frequency-efficiency parameters and one or more frequency-phase delay parameters.

13. The sound outputting apparatus according to claim 8, wherein the compensation parameters are used to minimize or eliminate deviations of outputs of the sound outputting units due to the real characteristics of the sound outputting units.

14. The sound outputting system according to claim 9, wherein the device comprises a controller, a signal source, and a signal processor.

15. The sound outputting system according to claim 14, wherein the controller connects with the memory unit, and is employed to read the compensation parameters of the sound outputting units.

16. The sound outputting system according to claim 14, wherein the signal processor is used to regulating outputs of the sound outputting units according to the compensation parameters.

17. The sound outputting system according to claim 9, wherein the device is an MP3 player.

18. The sound outputting system according to claim 9, wherein the device is a host computer.
